(19) United States
(12) Patent Application Publication
(10) Pub. No.: US 2024/0213517 A1
(43) Pub. Date: Jun. 27, 2024

(54) NON-AQUEOUS RECHARGEABLE BATTERY AND METHOD FOR MANUFACTURING NON-AQUEOUS RECHARGEABLE BATTERY

(71) Applicants: PRIMEARTH EV ENERGY CO., LTD., Kosai-shi (JP); TOYOTA JIDOSHA KABUSHIKI KAISHA, Tokyo-shi (JP); PRIME PLANET ENERGY & SOLUTIONS, INC., Tokyo (JP)

(72) Inventor: Shunya MARUYAMA, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/393,337

(22) Filed: Dec. 21, 2023

(30) Foreign Application Priority Data
Dec. 26, 2022 (JP) 2022-207954

(51) Int. Cl. H01M 10/04

(52) U.S. Cl. CPC H01M 10/045; H01M 10/0459; H01M 10/0468

(57) ABSTRACT

A non-aqueous rechargeable battery includes an electrode body formed by rolling a stack of positive and negative electrode plates with a separator that holds a non-aqueous electrolyte solution disposed in between. The electrode body includes a curved portion in which layers of the electrode body are curved. The positive electrode plate includes a foil of a positive electrode substrate and a positive electrode mixture layer applied to the positive electrode substrate. The negative electrode plate includes a foil of a negative electrode substrate and a negative electrode mixture layer applied to the negative electrode substrate. The negative electrode mixture layer includes a negative electrode active material that intercalates a charge carrier during charging. A coefficient of static friction between the negative electrode mixture layer and the separator is 0.60 or greater. A coefficient of static friction between the positive electrode mixture layer and the separator is 0.50 or less.

### BACKGROUND

### 1. Field

The following description relates to a non-aqueous rechargeable battery and a method for manufacturing a non-aqueous rechargeable battery.

### 2. Description of Related Art

Electric vehicles and hybrid vehicles are powered by non-aqueous rechargeable batteries. A lithium-ion battery, which is an example of a non-aqueous rechargeable battery, includes an electrode body in which a positive electrode plate, a negative electrode plate, and separators are stacked. For example, the electrode body includes a flat portion and curved portions located at opposite ends of the flat portion. The layers in the electrode body are pressed in the flat portion and are curved in the curved portion (for example, see Japanese Laid-Open Patent Publication No. 2020-161293). For example, the electrode body is accommodated in a box-shaped case such that the flat portion faces the side walls of the case and the curved portions are located above and below the flat portion.

### SUMMARY

During charging of the lithium-ion rechargeable battery, the negative electrode plate expands when lithium ions, serving as charge carriers, are intercalated into a negative electrode active material in the negative electrode plate. This increases the thickness of the negative electrode plate. In the flat portion, even when the negative electrode plate is increased in thickness due to the expansion of the negative electrode active material during charging, the flat portion is constrained by the side walls of the case. Thus, the negative electrode plate remains in contact with the separators.

In the curved portions, as the negative electrode active material expands during charging, the negative electrode plate is increased in thickness outwardly from the curved portions. In this case, when the coefficient of static friction between the negative electrode plate and the separator is small, the negative electrode plate will move along the separator and become warped. This may form a gap between the negative electrode plate and the separator. Such a gap between the negative electrode plate and the separator will increase the distance between the positive electrode plate and the negative electrode plate, or the inter-electrode distance. Thus, the resistance of the electrode body will become locally high. This will lower the lithium deposition resistance of the electrode body. In a non-aqueous rechargeable battery other than a lithium-ion rechargeable battery, expansion of the negative electrode active material during charging may also produce gaps that result in the metal ions serving as charge carriers forming metal depositions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a non-aqueous rechargeable battery includes an electrode body formed by rolling a stack of a positive electrode plate and a negative electrode plate with a separator that holds a non-aqueous electrolyte solution disposed in between. The electrode body includes a curved portion in which layers of the electrode body are curved. The positive electrode plate includes a foil of a positive electrode substrate and a positive electrode mixture layer applied to each of two opposite surfaces of the positive electrode substrate. The negative electrode plate includes a foil of a negative electrode substrate and a negative electrode mixture layer applied to each of two opposite surfaces of the negative electrode substrate. The negative electrode mixture layer includes a negative electrode active material that intercalates a charge carrier during charging of the non-aqueous rechargeable battery. A coefficient of static friction between the negative electrode mixture layer and the separator is greater than or equal to 0.60. A coefficient of static friction between the positive electrode mixture layer and the separator is less than or equal to 0.50.

In the non-aqueous rechargeable battery, the coefficient of static friction between the positive electrode mixture layer and the separator may be greater than or equal to 0.30.

In the non-aqueous rechargeable battery, a surface of the positive electrode mixture layer that contacts the separator may have a surface roughness in a range of 0.5 μm to 0.7 μm, inclusive, and a surface of the separator that contacts the positive electrode mixture layer may have a surface roughness in a range of 0.5 μm to 0.7 μm, inclusive.

In the non-aqueous rechargeable battery, a surface of the negative electrode mixture layer that contacts the separator may have a surface roughness in a range of 0.6 μm to 0.8 μm, inclusive, and a surface of the separator that contacts the negative electrode mixture layer may have a surface roughness in a range of 0.5 μm to 0.7 μm, inclusive.

In another general aspect, a method for manufacturing a non-aqueous rechargeable battery includes manufacturing an electrode body by rolling a stack of a positive electrode plate and a negative electrode plate with a separator disposed in between so that the manufactured electrode body includes a curved portion in which stacked layers are curved. The positive electrode plate includes a positive electrode substrate and a positive electrode mixture layer applied to each of two opposite surfaces of the positive electrode substrate. The negative electrode plate includes a negative electrode substrate and a negative electrode mixture layer applied to each of two opposite surfaces of the negative electrode substrate. The negative electrode mixture layer includes a negative electrode active material that intercalates a charge carrier during charging of the non-aqueous rechargeable battery. The separator is configured to hold a non-aqueous electrolyte solution. The method further includes injecting the non-aqueous electrolyte solution into a case accommodating the electrode body. In the electrode body manufactured in the manufacturing an electrode body, a coefficient of static friction between the negative electrode mixture layer and the separator is greater than or equal to 0.60, and a coefficient of static friction between the positive electrode mixture layer and the separator is less than or equal to 0.50.

Other features and aspects will be apparent from the following detailed description, the drawings, and the claims.

### BRIEF DESCRIPTION OF THE DRAWING

FIG. 1 is a perspective view of a lithium-ion rechargeable battery.

FIG. 2 is a perspective view of an electrode body in an unrolled state.

FIG. 3 is a cross-sectional view taken along line III-III shown in FIG. 2.

FIG. 4 is a cross-sectional view schematically showing a layered structure in a curved portion of the electrode body.

FIG. 5 is a flowchart illustrating a process for manufacturing the lithium-ion rechargeable battery.

FIG. 6 is a cross-sectional view schematically showing the layered structure in the curved portion during charging.

FIG. 7 is an enlarged cross-sectional view showing the layered structure in the curved portion during charging.

FIG. 8 is a table showing a first static friction coefficient, a second static friction coefficient, and a deposition limit current ratio in examples and comparative examples.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

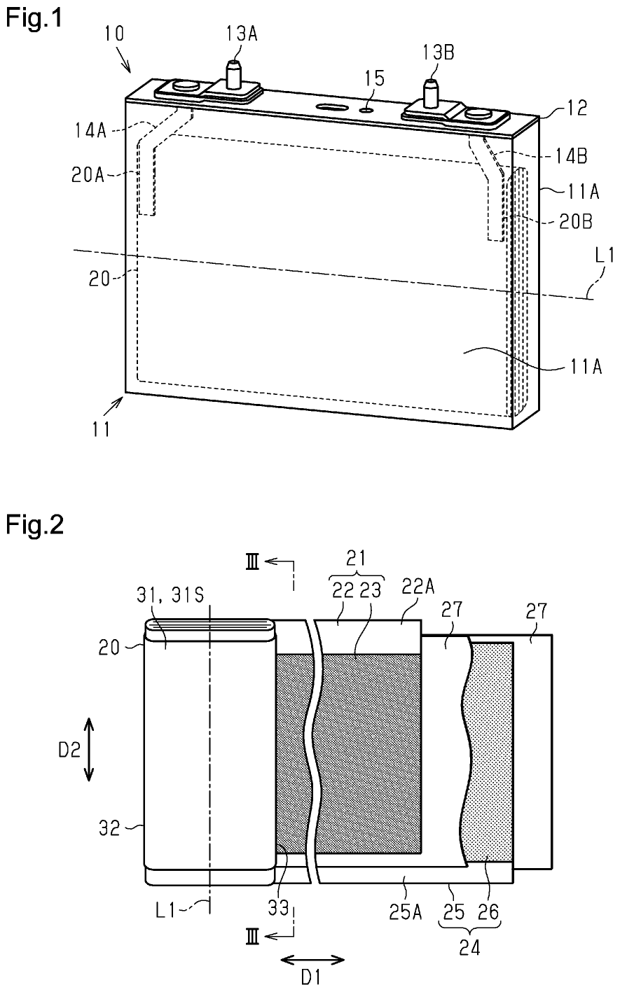

An embodiment of the present disclosure will now be described with reference to FIGS. 1 to 7.

### Lithium-Ion Rechargeable Battery

As shown in FIG. 1, a lithium-ion rechargeable battery 10, which is an example of a non-aqueous rechargeable battery, includes a case 11 and an electrode body 20. The case 11 is box-shaped and has an open upper end. The case 11 accommodates the electrode body 20 and a non-aqueous electrolyte solution. The case 11 includes two side walls 11A that face each other. A lid 12 closes the opening of the case 11. The case 11 forms a sealed box-shaped battery container by attaching the lid 12 to the case 11.

An external terminal 13A of the positive electrode and an external terminal 13B of the negative electrode are arranged on the lid 12. A positive electrode current collector portion 20A, which is the positive end of the electrode body 20, is electrically connected by a positive electrode current collector member 14A to the positive electrode external terminal 13A. A negative electrode current collector portion 20B, which is the negative end of the electrode body 20, is electrically connected by a negative electrode current collector member 14B to the negative electrode external terminal 13B. The lid 12 includes an inlet 15 for injection of the non-aqueous electrolyte solution. The external terminals 13A and 13B do not have to be shaped as shown in FIG. 1 and may have any shape.

The lithium-ion rechargeable battery 10 is used, for example, in a state in which multiple lithium-ion rechargeable batteries 10 are arranged next to one another in a battery pack. In the battery pack, for example, the lithium-ion rechargeable batteries 10 are arranged next to one another in a predetermined arrangement direction such that the side walls 11A of adjacent lithium-ion rechargeable batteries face each other. In this state, a binding load is applied to hold the lithium-ion rechargeable batteries 10 in the arrangement direction. This holds the lithium-ion rechargeable batteries 10 together.

### Electrode Body

As shown in FIG. 2, the electrode body 20 is a flat rolled body formed by rolling a stack of a positive electrode plate 21, a negative electrode plate 24, and separators 27. The positive electrode plate 21, the negative electrode plate 24, and the separators 27 are stacked so that their long sides are parallel to a longitudinal direction D1. The electrode body 20 is structured by rolling the stack of the positive electrode plate 21 and the negative electrode plate 24 with the separators 27 held in between about a rolling axis L1 that extends in a widthwise direction D2 of the strips.

The electrode body 20 includes a flat portion 31, an upper curved portion 32, and a lower curved portion 33. The flat portion 31 includes two flat surfaces 31S facing opposite directions. The upper curved portion 32 is located above the flat portion 31. The upper curved portion 32 is bulged upwardly from the upper end of the flat portion 31. The lower curved portion 33 is located below the flat portion 31. The lower curved portion 33 is bulged downwardly from the lower end of the flat portion 31. The upper curved portion 32 and the lower curved portion 33 are each an example of a curved portion of the electrode body 20.

The electrode body 20 is accommodated in the case 11 in a state in which the rolling axis L1 extends parallel to the bottom surface of the case 11 so that the upper curved portion 32 is located toward the lid 12, and the lower curved portion 33 is located toward the bottom surface of the case 11. Further, the electrode body 20 is accommodated in the case 11 in a state in which each flat surface 31S of the flat portion 31 faces a corresponding side wall 11A of the case 11.

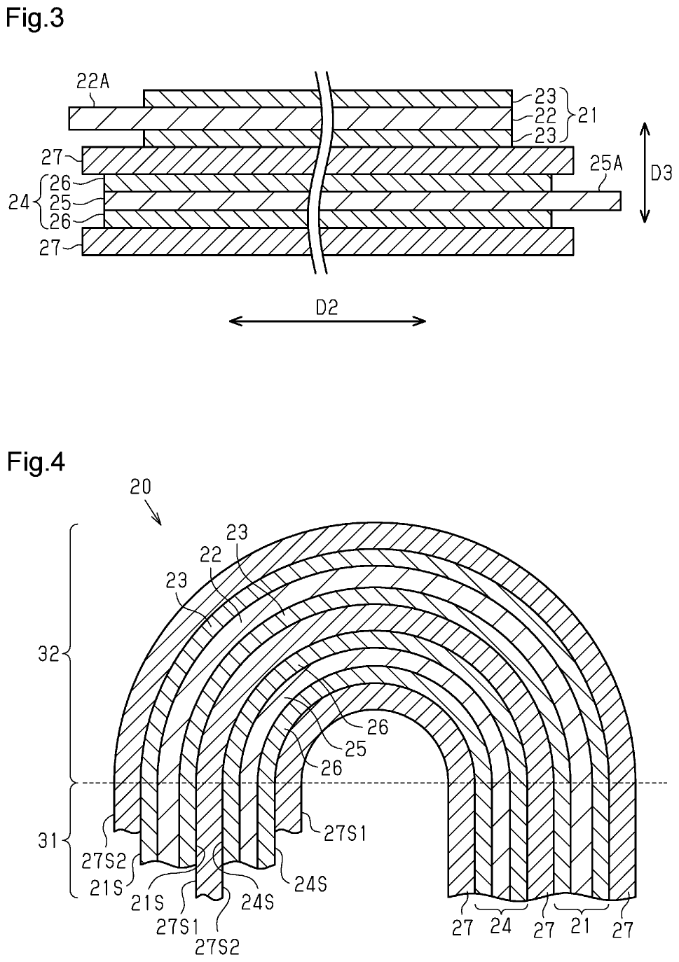

As shown in FIG. 3, in the electrode body 20, the positive electrode plate 21 and the negative electrode plate 24 are stacked with the separator 27 disposed in between in a stacking direction D3. The stacking direction D3 is orthogonal to a plane along which the longitudinal direction D1 and the widthwise direction D2 extend.

### Positive Electrode Plate

The positive electrode plate 21 includes a positive electrode substrate 22 and a positive electrode mixture layer 23. The positive electrode substrate 22 is a foil of a metal such as aluminum or an aluminum alloy. The positive electrode mixture layer 23 is applied to each of two opposite surfaces of the positive electrode substrate 22. One end of the positive electrode substrate 22 in the widthwise direction D2 includes a positive electrode uncoated portion 22A where the positive electrode mixture layer 23 is not formed such that the positive electrode substrate 22 is exposed. In the roll, opposing parts in the positive electrode uncoated portion 22A of the positive electrode substrate 22 are press-bonded to form the positive electrode current collector portion 20A.

The positive electrode mixture layer 23 includes a positive electrode active material, a positive electrode conductive agent, and a positive electrode binder. A positive electrode mixture paste, which serves as a precursor of the positive electrode mixture layer 23, further includes a positive electrode solvent. For example, the positive electrode solvent is an N-methyl-2-pyrrolidone (NMP) solution, which is an example of an organic solvent.

The positive electrode active material is a lithium-containing composite metal oxide that allows for intercalation and deintercalation of lithium ions, which serve as the charge carriers of the lithium-ion rechargeable battery 10. The positive electrode active material releases lithium ions during charging and stores lithium ions during discharging. The lithium-containing composite metal oxide is an oxide containing lithium and a metal element other than lithium. The metal element other than lithium is, for example, one selected from a group consisting of nickel, cobalt, manganese, vanadium, magnesium, molybdenum, niobium, titanium, tungsten, aluminum, and iron contained as iron phosphate in the lithium-containing composite metal oxide.

The lithium-containing composite metal oxide may be, for example, lithium cobalt oxide (LiCoO₂), lithium nickel oxide (LiNiO₂), or lithium manganese oxide (LiMn₂O₄). Further, the lithium-containing composite metal oxide may be, for example, a three-element lithium-containing composite metal oxide (NCM) that contains nickel, cobalt, and manganese, that is, lithium nickel manganese cobalt oxide (LiNiCoMnO₂). Further, the lithium-containing composite metal oxide may be, for example, lithium iron phosphate (LiFePO₄). For example, the positive electrode active material has a particle diameter (median diameter D50) in a range of 2 μm to 6 μm, inclusive.

The positive electrode conductive agent is, for example, carbon black such as acetylene black (AB) or ketjen black, carbon fibers such as carbon nanotubes (CNT) or carbon nanofibers, or graphite. The positive electrode binder is, for example, at least one selected from a group consisting of polyvinylidene fluoride (PVDF), polyvinyl alcohol (PVA), and styrene-butadiene rubber (SBR).

The positive electrode plate 21 may include an insulating layer between the positive electrode uncoated portion 22A and the positive electrode mixture layer 23. The insulating layer includes an insulative inorganic component and a resin component that functions as a binder. The inorganic material is at least one selected from a group consisting of powdered boehmite, titania, and alumina. The resin component is at least one selected from a group consisting of PVDF, PVA, and acrylic.

### Negative Electrode Plate

The negative electrode plate 24 includes a negative electrode substrate 25 and a negative electrode mixture layer 26. The negative electrode substrate 25 is a foil of a metal such as copper or a copper alloy. The negative electrode mixture layer 26 is applied to each of two opposite surfaces of the negative electrode substrate 25. One end of the negative electrode substrate 25 in the widthwise direction D2 at the side opposite the positive electrode uncoated portion 22A includes a negative electrode uncoated portion 25A where the negative electrode mixture layer 26 is not formed such that the negative electrode substrate 25 is exposed. In the roll, opposing parts in the negative electrode uncoated portion 25A are press-bonded to form the negative electrode current collector portion 20B.

The negative electrode mixture layer 26 includes a negative electrode active material, a negative electrode conductive agent, a negative electrode viscosity increasing agent, and a negative electrode binder. Further, a negative electrode mixture paste, which serves as a precursor of the negative electrode mixture layer 26, further includes a negative electrode solvent. An example of the negative electrode solvent is water. The negative electrode active material allows for intercalation and deintercalation of lithium ions. The negative electrode active material stores lithium ions during charging and releases lithium ions during discharging. The negative electrode active material is, for example, a carbon material such as graphite, hard carbon, soft carbon, or carbon nanotubes. The negative electrode active material may be composite particles in which graphite particles are coated with an amorphous carbon layer. For example, the negative electrode active material has a particle diameter (median diameter D50) in a range of 5 μm to 10 μm, inclusive.

The negative electrode conductive agent may be the same material as the positive electrode conductive agent. An example of the negative electrode viscosity increasing agent may be carboxymethyl cellulose (CMC). The CMC also serves as a dispersant that disperses the negative electrode active material in the negative electrode mixture paste. The negative electrode binder is at least one selected from a group consisting of PVDF, PVA, and SBR.

### Separator

The separators 27 prevent contact between the positive electrode plate 21 and the negative electrode plate 24 in addition to holding the non-aqueous electrolyte solution between the positive electrode plate 21 and the negative electrode plate 24. Immersion of the electrode body 20 in the non-aqueous electrolyte solution results in the non-aqueous electrolyte solution permeating the separators 27 from the ends toward the center.

Each separator 27 is a porous nonwoven fabric of polypropylene or the like. The separator 27 may be, for example, a porous polymer film, such as a porous polyethylene film, a porous polyolefin film, or a porous polyvinyl chloride film, an ion conductive polymer electrolyte film, or the like.

The separator 27 has a porosity ε, for example, in a range of 50% to 60%, inclusive. When masses of the components included in the separator 27 per unit volume W0 are represented by Wa, Wb, . . . Wn, and true densities of the components are represented by pa, pb, . . . pn, the porosity ε is expressed by the following equation ε={1−(Wa/pa+Wb/pb . . . +Wn/pn)/W0}×100.

### Non-Aqueous Electrolyte Solution

The non-aqueous electrolyte solution is a composition containing a supporting electrolyte in a non-aqueous solvent. The non-aqueous solvent is, for example, one or two or more selected from a group consisting of propylene carbonate, ethylene carbonate, diethyl carbonate, dimethyl carbonate, and ethyl methyl carbonate. The supporting electrolyte is, for example, a lithium compound of one or two or more selected from a group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

A film forming agent is added to the non-aqueous electrolyte solution. The film forming agent is, for example, lithium bis(oxalate) borate (LiBOB). For example, LiBOB is added to the non-aqueous electrolyte solution so that the concentration of LiBOB in the non-aqueous electrolyte solution is in a range of 0.001 mol/L to 0.1 mol/L, inclusive.

### Friction Coefficient Between Layers of Electrode Body

As shown in FIG. 4, the positive electrode plate 21 includes a positive electrode contact surface 21S that is in contact with the separator 27. The positive electrode contact surface 21S is a surface of the positive electrode mixture layer 23. The positive electrode plate 21 includes two positive-electrode contact surfaces 21S facing opposite directions. The negative electrode plate 24 includes a negative electrode contact surface 24S that is in contact with the separator 27. The negative electrode contact surface 24S is a surface of the negative electrode mixture layer 26. The negative electrode plate 24 includes two negative-electrode contact surfaces 24S facing opposite directions. The separator 27 includes a first contact surface 27S1 and a second contact surface 27S2. The first contact surface 27S1 is a surface of the separator 27 that is in contact with the positive electrode contact surface 21S. The second contact surface 27S2 is a surface of the separator 27 that is in contact with the negative electrode contact surface 24S.

The positive electrode mixture layer 23 and the separator 27 are configured so that a first static friction coefficient μ1 between the positive electrode mixture layer 23 and the separator 27 is less than or equal to 0.50. Also, it is preferred that the first static friction coefficient μ1 be greater than or equal to 0.30. The first static friction coefficient μ1 is the coefficient of static friction between the positive electrode contact surface 21S of the positive electrode mixture layer 23 formed on the positive electrode plate 21 and the first contact surface 27S1 of the separator 27 in a dry state. In a dry state, the separator 27 does not hold the non-aqueous electrolyte solution.

The negative electrode mixture layer 26 and the separator 27 are configured so that a second static friction coefficient μ2 between the negative electrode mixture layer 26 and the separator 27 is greater than or equal to 0.60. The second static friction coefficient μ2 is the coefficient of static friction between the negative electrode contact surface 24S of the negative electrode mixture layer 26 formed on the negative electrode plate 24 and the second contact surface 27S2 of the separator 27 in a dry state. The upper limit of the second static friction coefficient μ2 is not particularly limited as long as it is less than or equal to 1.00.

The positive electrode plate 21 and the separator 27 in a dry state are used to measure the first static friction coefficient μ1 by a method conforming to JIS K7125:1999. For example, the positive electrode plate 21 is set such that the positive electrode mixture layer 23 is in contact with the separator 27 in a dry state, and then the positive electrode plate 21 is moved along the separator 27 at a speed of 100 mm/min to measure the coefficient of static friction. The negative electrode plate 24 and the separator 27 in a dry state are used to measure the second static friction coefficient μ2 by the same method as the first static friction coefficient μ1.

In an example, the first static friction coefficient μ1 and the second static friction coefficient μ2 may be measured using the positive electrode plate 21, the negative electrode plate 24, and the separators 27 before the layers are rolled into the electrode body 20 to manufacture the lithium-ion rechargeable battery 10.

When the first static friction coefficient μ1 and the second static friction coefficient μ2 are measured by disassembling the lithium-ion rechargeable battery 10, for example, the electrode body 20 is first removed from the case 11 to avoid unnecessary damage. Then, the electrode body 20 is separated into the positive electrode plate 21, the negative electrode plate 24, and the two separators 27. Subsequently, the non-aqueous electrolyte solution is sufficiently washed off of the positive electrode plate 21, the negative electrode plate 24, and the separators 27 with an organic solvent. When the components are dried, the first static friction coefficient μ1 and the second static friction coefficient μ2 can be measured.

### Method for Manufacturing Lithium-Ion Rechargeable Battery

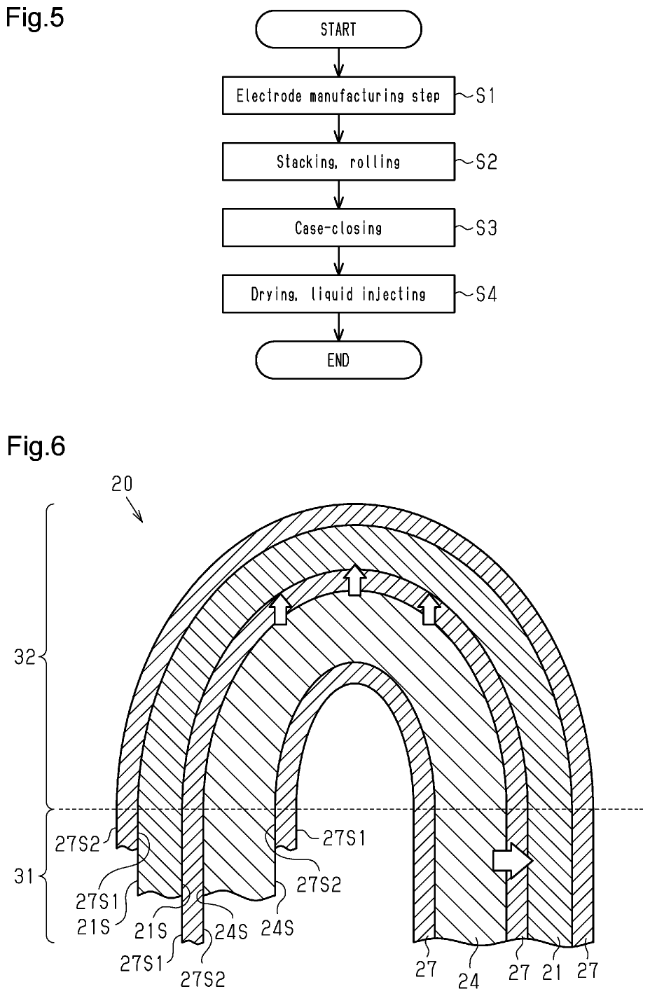

As shown in FIG. 5, a method for manufacturing the lithium-ion rechargeable battery 10 includes steps S1 to S4. Step S1 includes a step of manufacturing the positive electrode plate 21 and a step of manufacturing the negative electrode plate 24. The step of manufacturing the positive electrode plate 21 includes a step of applying a positive electrode mixture paste to the positive electrode substrate 22, a step of drying the positive electrode mixture paste to form the positive electrode mixture layer 23, and a step of pressing the positive electrode mixture layer 23 to adjust the thickness of the positive electrode mixture layer 23. The step of manufacturing the negative electrode plate 24 includes a step of applying a negative electrode mixture paste to the negative electrode substrate 25, a step of drying the negative electrode mixture paste to form the negative electrode mixture layer 26, and a step of pressing the negative electrode mixture layer 26 to adjust the thickness of the negative electrode mixture layer 26.

Step S2 is a step of manufacturing the electrode body 20 using the positive electrode plate 21, the negative electrode plate 24, and the separators 27. In step S2, the stack of the positive electrode plate 21 and the negative electrode plate 24 with the separators 27 disposed in between is rolled. Then, the rolled stack is pressed and flattened. Then, opposing parts in the positive electrode uncoated portion 22A are press-bonded to form the positive electrode current collector portion 20A. Further, opposing parts in the negative electrode uncoated portion 25A are press-bonded to form the negative electrode current collector portion 20B. The electrode body 20 is manufactured through these steps.

Step S3 is a step of accommodating the electrode body 20 in the case 11. In step S3, the positive electrode current collector portion 20A is electrically connected by the positive electrode current collector member 14A to the positive electrode external terminal 13A. The negative electrode current collector portion 20B is electrically connected by the negative electrode current collector member 14B to the negative electrode external terminal 13B. After the electrode body 20 is accommodated in the case 11, the upper opening of the case 11 is closed by the lid 12.

In step S4, the electrode body 20 accommodated in the case 11 is dried, and then the non-aqueous electrolyte solution is injected into the case 11. Subsequently, the lithium-ion rechargeable battery 10 undergoes an aging process and an initial charging process. This manufactures the lithium-ion rechargeable battery 10. When the lithium-ion rechargeable battery 10 is used in a battery pack, multiple lithium-ion rechargeable batteries 10 are arranged next to one another in a predetermined arrangement direction such that the side walls 11A of adjacent lithium-ion rechargeable batteries 10 face each other. Then, a binding load is applied to the lithium-ion rechargeable batteries 10 with binding bands, a battery pack casing, end plates, and the like.

### Operation of Present Embodiment

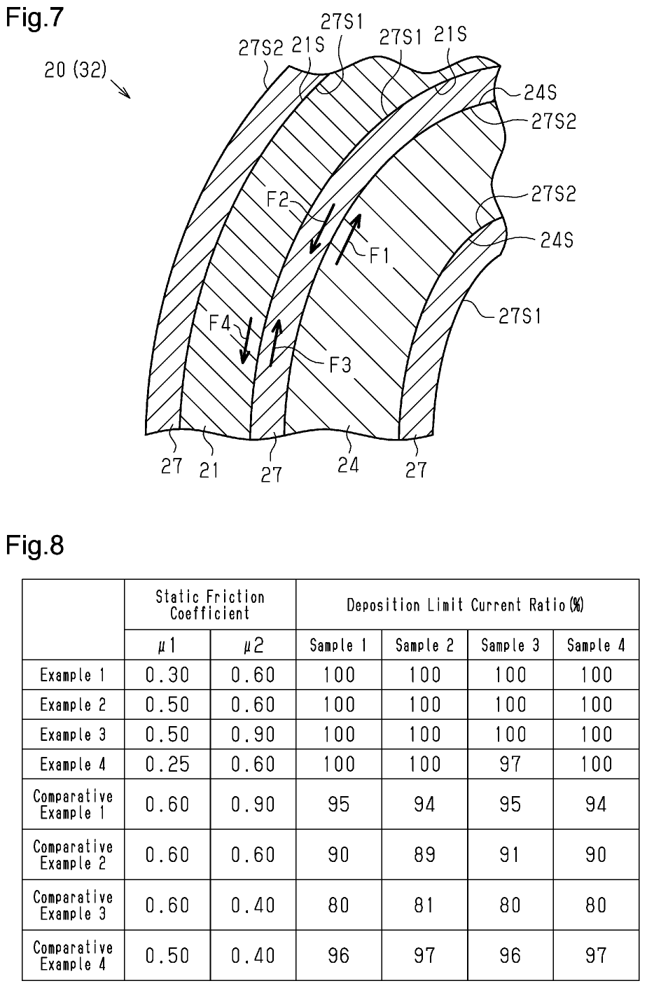

The operation of the present embodiment will now be described with reference to FIGS. 6 and 7.

As shown in FIG. 6, when the lithium-ion rechargeable battery 10 is being charged, the negative electrode mixture layer 26 expands when lithium ions, serving as charge carriers, are intercalated into the negative electrode active material. In this case, even if the negative electrode mixture layer 26 is expanded, the electrode body 20 is constrained by the side walls 11A in the flat portion 31. This restricts excess increase in the thickness of the negative electrode plate 24 in the flat portion 31, which is caused by the expansion of the negative electrode mixture layer 26 during charging of the lithium-ion rechargeable battery 10. In particular, when the lithium-ion rechargeable battery 10 is used in a battery pack, the binding load applied to the battery pack limits deformation of the side walls 11A. Thus, excessive increase in the thickness of the negative electrode plate 24 is restricted in the flat portion 31 in a preferred manner.

Since the electrode body 20 is not constrained at the top and the bottom, the expansion of the negative electrode mixture layer 26 during charging increases the negative electrode plate 24 in thickness outwardly from the upper curved portion 32 and the lower curved portion 33. In other words, during charging, the negative electrode plate 24 is stretched in the top-bottom direction by the expansion of the negative electrode mixture layer 26.

In an example, charging is performed to increase the state of charge (SOC) from SOC 10% to SOC 90%. In this case, the expansion rate (increase rate of thickness) of the negative electrode mixture layer 26 in the upper curved portion 32 and the lower curved portion 33 is in a range of 110% to 120%, inclusive. That is, in the upper curved portion 32 and the lower curved portion 33, the thickness of the negative electrode mixture layer 26 at SOC of 90% is 1.1 to 1.2 times greater than the thickness of the negative electrode mixture layer 26 at SOC of 10%. The present disclosure is particularly suitable for a non-aqueous rechargeable battery including the negative electrode mixture layer 26 that is increased in thickness by 1.1 to 1.2 times during charging.

As shown in FIG. 7, in the upper curved portion 32 and the lower curved portion 33, as the negative electrode mixture layer 26 expands during charging, an expansion force F1 increases the negative electrode plate 24 in thickness outwardly from the electrode body 20. At the same time, a negative electrode static frictional force F2 acts between the negative electrode contact surface 24S of the negative electrode plate 24 and the second contact surface 27S2 of the separator 27. The negative electrode static frictional force F2 is generated between the negative electrode plate 24 and both the separator 27 located at the outer circumferential side and the separator 27 located at the inner circumferential side.

If the second static friction coefficient μ2 is too small, the maximum value of the negative electrode static frictional force F2 may be smaller than the expansion force F1 acting on the negative electrode plate 24. In this case, the negative electrode plate 24 will move along the second contact surface 27S2 of the separator 27 and become warped. Thus, a gap is likely to be formed between the negative electrode plate 24 and the separator 27. In the electrode body 20, such a gap between the negative electrode plate 24 and the separator 27 will increase the distance between the positive electrode plate 21 and the negative electrode plate 24, or the inter-electrode distance. Thus, the resistance of the electrode body 20 will become locally high. Since lithium is likely to deposit on the portion of the electrode body 20 where the resistance is locally high, the amount of lithium contributing to charging and discharging may be decreased. This lowers the battery performance.

In this respect, the second static friction coefficient μ2 is set to 0.60 or greater. This increases the maximum value of the negative electrode static frictional force F2 so that the separator 27 stretches in correspondence with the increase in the thickness of the negative electrode plate 24 during charging while the separator 27 remains in contact with the negative electrode mixture layer 26. This avoids warping of the negative electrode plate 24 that occurs when the second static friction coefficient μ2 between the negative electrode plate 24 and the separator 27 is too small, and restricts formation of a gap between the negative electrode plate 24 and the separator 27.

Further, when the separator 27 stretches in correspondence with the increase in the thickness of the negative electrode plate 24 during charging, a stretching force F3 acts on the separator 27 outwardly from the electrode body 20. The stretching force F3 acting on the separator 27 is greater than a positive electrode static frictional force F4 between the positive electrode contact surface 21S of the positive electrode plate 21 and the first contact surface 27S1 of the separator 27. Thus, after the positive electrode static frictional force F4 acts between the positive electrode contact surface 21S and the first contact surface 27S1, the stretching force F3 moves and stretches the separator 27 on the positive electrode contact surface 21S.

If the first static friction coefficient μ1 is too large, the positive electrode static frictional force F4 between the positive electrode plate 21 and the separator 27 resists deformation of the separator 27. This limits the stretching of the separator 27 in correspondence with the increase in the thickness of the negative electrode plate 24. In this case, in which the positive electrode plate 21 restricts the deformation of the separator 27, the negative electrode plate 24 is likely to move and deform on the separator 27. This may form a gap between the negative electrode plate 24 and the separator 27.

In this respect, the first static friction coefficient μ1 is set to 0.50 or less. Thus, the positive electrode static frictional force F4 will not hinder deformation of the separator 27 when the separator 27 is stretched in correspondence with the increase in the thickness of the negative electrode plate 24. This avoids formation of a gap between the negative electrode plate 24 and the separator 27 in a preferred manner.

If the first static friction coefficient μ1 is too large and the coefficient of dynamic friction between the positive electrode plate 21 and the separator 27 is large, the dynamic frictional force between the positive electrode plate 21 and the separator 27 may resist the deformation of the separator 27. In this respect, the first static friction coefficient μ1 is set to 0.50 or less. Since the coefficient of dynamic friction between the positive electrode plate 21 and the separator 27 is less than or equal to the first static friction coefficient μ1, the dynamic frictional force between the positive electrode plate 21 and the separator 27 will not hinder deformation of the separator 27.

Also, if the first static friction coefficient μ1 is too small, the positive electrode plate 21 may move relative to the separator 27 that is located at the inner side of the positive electrode plate 21 when rolled to manufacture the electrode body 20. This may result in the positive electrode plate 21 being rolled in a meandering state on the separator 27. In the same manner, the other separator 27 may move relative to the positive electrode plate 21 that is located at the inner side of the separator 27 when rolled. This may result in the separator 27 being rolled in a meandering state on the positive electrode plate 21. In this respect, the first static friction coefficient μ1 is set to 0.30 or greater. Thus, the positive electrode plate 21 will not be rolled in a meandering state on the separator 27.

### Method for Controlling Static Friction Coefficient

The first static friction coefficient μ1 has a positive correlation with a surface roughness Ra1 of the positive electrode contact surface 21S of the positive electrode mixture layer 23 formed on the positive electrode plate 21. The first static friction coefficient μ1 has a positive correlation with a surface roughness Ra2 of the first contact surface 27S1 of the separator 27. The second static friction coefficient μ2 has a positive correlation with a surface roughness Ra3 of the negative electrode contact surface 24S of the negative electrode mixture layer 26 formed on the negative electrode plate 24. The second static friction coefficient μ2 has a positive correlation with a surface roughness Ra4 of the second contact surface 27S2 of the separator 27.

The surface roughness Ra1 to Ra4 are measured by a method that conforms to a process for measuring the arithmetic mean surface roughness (Ra) specified in JIS B0601:2013. The surface roughness Ra2 of the first contact surface 27S1 of the separator 27 is measured at the portion of the first contact surface 27S1 where there are no pores. The surface roughness Ra4 of the second contact surface 27S2 of the separator 27 is measured at the portion of the second contact surface 27S2 where there are no pores.

In an example, the surface roughness Ra1 of the positive electrode contact surface 21S is adjusted by changing the surface roughness of a press roll used in the step of pressing the positive electrode mixture layer 23 to adjust the thickness in the electrode plate manufacturing step S1 of the manufacturing process of the positive electrode plate 21. For example, the surface roughness Ra1 of the positive electrode contact surface 21S may be increased by pressing the positive electrode mixture layer 23 with a press roll having a high surface roughness. For example, the surface roughness Ra1 of the positive electrode contact surface 21S may be decreased by pressing the positive electrode mixture layer 23 with a press roll having a low surface roughness. The surface roughness Ra3 of the negative electrode contact surface 24S is adjusted by, for example, changing the surface roughness of a press roll that presses the negative electrode mixture layer 26 in the electrode plate manufacturing step S1.

The first static friction coefficient μ1 and the second static friction coefficient μ2 may be varied by adjusting the manufacturing condition of the separator 27 so as to change the surface roughness Ra2 of the first contact surface 27S1 and the surface roughness Ra4 of the second contact surface 27S2.

The positive electrode contact surface 21S has a surface roughness Ra1, for example, in a range of 0.5 μm to 0.7 μm, inclusive. Further, the first contact surface 27S1 has a surface roughness Ra2, for example, in a range of 0.5 μm to 0.7 μm, inclusive. A state in which the surface roughness Ra1 of the positive electrode contact surface 21S and the surface roughness Ra2 of the first contact surface 27S1 are in the above ranges is an example of a state in which the first static friction coefficient μ1 is in a range of 0.30 to 0.50, inclusive.

The negative electrode contact surface 24S has a surface roughness Ra3, for example, in a range of 0.6 μm to 0.8 μm, inclusive. Further, the second contact surface 27S2 has a surface roughness Ra4, for example, in a range of 0.5 μm to 0.7 μm, inclusive. A state in which the surface roughness Ra3 of the negative electrode contact surface 24S and the surface roughness Ra4 of the second contact surface 27S2 are in the above ranges is an example of a state in which the second static friction coefficient μ2 is greater than or equal to 0.60.

The first static friction coefficient μ1 has a positive correlation with the effective contact area of the positive electrode contact surface 21S of the positive electrode plate 21 and the first contact surface 27S1 of the separator 27. Thus, the first static friction coefficient μ1 may also be varied by adjusting the manufacturing condition of the separator 27 so as to change the contact area of the first contact surface 27S1 and the positive electrode contact surface 21S. The second static friction coefficient μ2 has a positive correlation with the effective contact area of the negative electrode contact surface 24S of the negative electrode plate 24 and the second contact surface 27S2 of the separator 27. Thus, the second static friction coefficient μ2 may also be varied by adjusting the manufacturing condition of the separator 27 so as to change the contact area of the second contact surface 27S2 and the negative electrode contact surface 24S.

In an example, an increase in the porosity ε of the separator 27 reduces the effective area of the first contact surface 27S1 and the positive electrode contact surface 21S by an amount corresponding to the increased pores located in the first contact surface 27S1. This also decreases the effective area of the second contact surface 27S2 and the negative electrode contact surface 24S by an amount corresponding to the increased pores located in the second contact surface 27S2. In this manner, both the first static friction coefficient μ1 and the second static friction coefficient μ2 may be decreased by increasing the porosity ε of the separator 27. Further, both the first static friction coefficient μ1 and the second static friction coefficient μ2 may be increased by decreasing the porosity ε of the separator 27.

### Advantages of the Embodiment

The above embodiment has the following advantages.

(1) When the second static friction coefficient μ2 is set to 0.60 or greater, the separator 27 is stretched in the upper curved portion 32 and the lower curved portion 33 in correspondence with the increase in the thickness of the negative electrode plate 24 during charging while maintaining the state in which the separator 27 is in contact with the negative electrode mixture layer 26. This avoids formation of a gap between the negative electrode plate 24 and the separator 27 in the upper curved portion 32 and the lower curved portion 33.

(2) When the first static friction coefficient μ1 is set to 0.50 or less, the positive electrode static frictional force F4 will not hinder deformation of the separator 27 in the upper curved portion 32 and the lower curved portion 33 during charging. This avoids formation of a gap between the negative electrode plate 24 and the separator 27 in the upper curved portion 32 and the lower curved portion 33 in a preferred manner.

(3) When the first static friction coefficient μ1 is set to 0.30 or greater, one of the positive electrode plate 21 and the separator 27 will not be rolled in a meandering state on the other one of the positive electrode plate 21 and the separator 27 when manufacturing the electrode body 20. This improves the yield rate of the lithium-ion rechargeable battery 10.

(4) When the surface roughness Ra1 of the positive electrode contact surface 21S is set in a range of 0.5 μm to 0.7 μm, inclusive, and the surface roughness Ra2 of the first contact surface 27S1 is set in a range of 0.5 μm to 0.7 μm, inclusive, the first static friction coefficient μ1 is controlled to be in a range of 0.30 to 0.50, inclusive.

(5) When the surface roughness Ra3 of the negative electrode contact surface 24S is set in a range of 0.6 μm to 0.8 μm, inclusive, and the surface roughness Ra4 of the second contact surface 27S2 is set in a range of 0.5 μm to 0.7 μm, inclusive, the second static friction coefficient μ2 is controlled to be greater than or equal to 0.60.

### Modified Examples

The above embodiment may be modified as described below. The following modifications can be combined as long as the combined modifications remain technically consistent with each other.

The surface roughness Ra3 of the negative electrode contact surface 24S may be less than 0.6 μm and/or greater than 0.8 μm as long as the second static friction coefficient μ2 is greater than or equal to 0.60. Further, the surface roughness Ra4 of the second contact surface 27S2 may be less than 0.5 μm and/or greater than 0.7 μm as long as the second static friction coefficient μ2 is greater than or equal to 0.60.

The surface roughness Ra1 of the positive electrode contact surface 21S may be less than 0.5 μm and/or greater than 0.7 μm as long as the first static friction coefficient μ1 is less than or equal to 0.50. The surface roughness Ra2 of the first contact surface 27S1 may be less than 0.5 μm and/or greater than 0.7 μm as long as the first static friction coefficient μ1 is less than or equal to 0.50.

The first static friction coefficient μ1 may be less than 0.30 as long as one of the positive electrode plate 21 and the separator 27 will not be rolled in a meandering state on the other one of the positive electrode plate 21 and the separator 27 when manufacturing the electrode body 20. Further, even if one of the positive electrode plate 21 and the separator 27 meanders relative to the other one of the positive electrode plate 21 and the separator 27, the first static friction coefficient μ1 may be less than 0.30 as long as the degree of meandering does not affect the product performance or a visual inspection or the like is conducted so that only electrode bodies 20 having no meandering are approved.

In the above-described example, the lithium-ion rechargeable battery 10 is used as a non-aqueous rechargeable battery. However, the present disclosure may be applied to any non-aqueous rechargeable battery including a negative electrode active material that expands during charging. In the above-described example, the negative electrode active material is formed from graphite. However, the present disclosure may also be applied to a non-aqueous rechargeable battery using a silicon-based negative electrode active material that expands during charging.

The lithium-ion rechargeable battery 10 may be used in an automatic transporting vehicle, a special hauling vehicle, a battery electric vehicle, a hybrid electric vehicle, a computer, an electronic device, or any other system. For example, the lithium-ion rechargeable battery 10 may be used in a marine vessel, an aircraft, or any other type of movable body. The lithium-ion rechargeable battery 10 may also be used in a system that supplies electric power from a power plant via a substation to buildings and households.

### Examples

Examples 1 to 4 and Comparative Examples 1 to 4 will now be described with reference to FIG. 8. Following examples are to illustrate the advantages of the above embodiment and not to limit the scope of the present disclosure.

### Example 1

As shown in FIG. 8, in Example 1, a lithium-ion rechargeable battery 10 was manufactured using an electrode body 20 in which the first static friction coefficient μ1 was set to 0.30, and the second static friction coefficient μ2 was set to 0.60. Specifically, in Example 1, four electrode bodies 20 using the same positive electrode plate 21, negative electrode plate 24, and separators 27 were prepared and then four lithium-ion rechargeable batteries 10 were manufactured as Samples 1 to 4 (n=4).

### Example 2

In Example 2, four electrode bodies 20 were prepared such that the first static friction coefficient μ1 was set to 0.50 and the second static friction coefficient μ2 was set to 0.60. Then, four lithium-ion rechargeable batteries 10 were manufactured as Samples 1 to 4 (n=4).

### Example 3

In Example 3, four electrode bodies 20 were prepared such that the first static friction coefficient μ1 was set to 0.50 and the second static friction coefficient μ2 was set to 0.90. Then, four lithium-ion rechargeable batteries 10 were manufactured as Samples 1 to 4 (n=4).

### Example 4

In Example 4, four electrode bodies 20 were prepared such that the first static friction coefficient μ1 was set to 0.25 and the second static friction coefficient μ2 was set to 0.60. Then, four lithium-ion rechargeable batteries 10 were manufactured as Samples 1 to 4 (n=4). In Sample 3 of Example 4, it was detected that the positive electrode plate 21 was rolled in a meandering state on the separator 27 when manufacturing the electrode body 20.

### Comparative Example 1

In Comparative Example 1, four electrode bodies 20 were prepared such that the first static friction coefficient μ1 was set to 0.60 and the second static friction coefficient μ2 was set to 0.90. Then, four lithium-ion rechargeable batteries 10 were manufactured as Samples 1 to 4 (n=4).

### Comparative Example 2

In Comparative Example 2, four electrode bodies 20 were prepared such that the first static friction coefficient μ1 was set to 0.60 and the second static friction coefficient μ2 was set to 0.60. Then, four lithium-ion rechargeable batteries 10 were manufactured as Samples 1 to 4 (n=4).

### Comparative Example 3

In Comparative Example 3, four electrode bodies 20 were prepared such that the first static friction coefficient μ1 was set to 0.60 and the second static friction coefficient μ2 was set to 0.40. Then, four lithium-ion rechargeable batteries 10 were manufactured as Samples 1 to 4 (n=4).

### Comparative Example 4

In Comparative Example 4, four electrode bodies 20 were prepared such that the first static friction coefficient μ1 was set to 0.50 and the second static friction coefficient μ2 was set to 0.40. Then, four lithium-ion rechargeable batteries 10 were manufactured as Samples 1 to 4 (n=4).

### Lithium Deposition Resistance Evaluation

Samples 1 to 4 manufactured in Examples 1 to 4 and Comparative Examples 1 to 4 were each measured for a first critical current value I1 at which metal lithium starts to deposit on the flat portion 31 during charging, and a second critical current value I2 at which metal lithium starts to deposit on the upper and lower curved portions 32 and 33 during charging. The second critical current value I2 corresponds to a current value at which metal lithium starts to deposit on at least one of the upper curved portion 32 and the lower curved portion 33 during charging. Then, a ratio of the second critical current value I2 to the first critical current value I1, or a deposition limit current ratio, was calculated from I2/I1×100 (%). In each sample manufactured in Examples 1 to 4 and Comparative Examples 1 to 4, when the sample was charged from SOC 10% to SOC 90%, the thickness of the negative electrode mixture layer 26 in the upper curved portion 32 and the lower curved portion 33 increased by 1.1 to 1.2 times.

As the deposition limit current ratio becomes closer to 100%, the lithium deposition resistance in the upper curved portion 32 and the lower curved portion 33 becomes closer to the lithium deposition resistance in the flat portion 31. Thus, when the deposition limit current ratio is close to 100%, formation of a gap between the negative electrode plate 24 and the separator 27 is avoided in the upper curved portion 32 and the lower curved portion 33.

### Evaluation Results

As shown in FIG. 8, in Examples 1 to 3, the deposition limit current ratio was 100% in each one of Samples 1 to 4. This indicates that formation of a gap is avoided between the negative electrode plate 24 and the separator 27 when the first static friction coefficient μ1 is in a range of 0.30 to 0.50, inclusive, and the second static friction coefficient μ2 is greater than or equal to 0.60.

In Example 4, Samples 1, 2, and 4 had a deposition limit current ratio of 100%, whereas Sample 3 had a deposition limit current ratio of 97%. It can be determined that the positive electrode plate 21, which was rolled in a meandering state on the separator 27 when manufacturing the electrode body 20, increased the resistance and decreased the second critical current value I2 in Sample 3 of Example 4. These results show that when the first static friction coefficient μ1 is set to 0.30 or greater, one of the positive electrode plate 21 and the separator 27 will not be rolled in a meandering state on the other one of the positive electrode plate 21 and the separator 27 when manufacturing the electrode body 20. This avoids an increase in the resistance resulting from meandering.

In Comparative Example 1, the deposition limit current ratio was approximately 94% to 95%. In Comparative Example 2, the deposition limit current ratio was approximately 89% to 91%. In Comparative Example 3, the deposition limit current ratio was approximately 80% to 81%. In Comparative Examples 1 to 3, the first static friction coefficient μ1 was 0.60, and thus the positive electrode static frictional force F4 was relatively large compared to those in Examples 1 to 4. Accordingly, it can be determined that, in Comparative Examples 1 to 3, the positive electrode static frictional force F4 hindered deformation of the separator 27 and formed a gap between the negative electrode plate 24 and the separator 27, decreasing the second critical current value I2. Also, as the second static friction coefficient μ2 decreases, a gap is further likely to be formed between the negative electrode plate 24 and the separator 27. Therefore, the deposition limit current ratio became lower in the order of Comparative Examples 1, 2, and 3.

In Comparative Example 4, the deposition limit current ratio was approximately 96% to 97%. In Comparative Example 4, the second static friction coefficient μ2 was 0.40, and thus the negative electrode static frictional force F2 was relatively small compared to those in Examples 1 to 4. Accordingly, it can be determined that, in Comparison Example 4, the separator 27 did not deform in correspondence with the deformation of the negative electrode plate 24 during charging and a gap was formed between the negative electrode plate 24 and the separator 27, decreasing the second critical current value I2.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A non-aqueous rechargeable battery, comprising:
an electrode body formed by rolling a stack of a positive electrode plate and a negative electrode plate with a separator that holds a non-aqueous electrolyte solution disposed in between, wherein
the electrode body includes a curved portion in which layers of the electrode body are curved,
the positive electrode plate includes a foil of a positive electrode substrate and a positive electrode mixture layer applied to each of two opposite surfaces of the positive electrode substrate,
the negative electrode plate includes a foil of a negative electrode substrate and a negative electrode mixture layer applied to each of two opposite surfaces of the negative electrode substrate,
the negative electrode mixture layer includes a negative electrode active material that intercalates a charge carrier during charging of the non-aqueous rechargeable battery,
a coefficient of static friction between the negative electrode mixture layer and the separator is greater than or equal to 0.60, and
a coefficient of static friction between the positive electrode mixture layer and the separator is less than or equal to 0.50.

2. The non-aqueous rechargeable battery according to claim 1, wherein the coefficient of static friction between the positive electrode mixture layer and the separator is greater than or equal to 0.30.

3. The non-aqueous rechargeable battery according to claim 2, wherein:
a surface of the positive electrode mixture layer that contacts the separator has a surface roughness in a range of 0.5 μm to 0.7 μm, inclusive; and
a surface of the separator that contacts the positive electrode mixture layer has a surface roughness in a range of 0.5 μm to 0.7 μm, inclusive.

4. The non-aqueous rechargeable battery according to claim 1, wherein:
a surface of the negative electrode mixture layer that contacts the separator has a surface roughness in a range of 0.6 μm to 0.8 μm, inclusive; and
a surface of the separator that contacts the negative electrode mixture layer has a surface roughness in a range of 0.5 μm to 0.7 μm, inclusive.

5. A method for manufacturing a non-aqueous rechargeable battery, the method comprising:
manufacturing an electrode body by rolling a stack of a positive electrode plate and a negative electrode plate with a separator disposed in between so that the manufactured electrode body includes a curved portion in which stacked layers are curved, wherein the positive electrode plate includes a positive electrode substrate and a positive electrode mixture layer applied to each of two opposite surfaces of the positive electrode substrate, the negative electrode plate includes a negative electrode substrate and a negative electrode mixture layer applied to each of two opposite surfaces of the negative electrode substrate, the negative electrode mixture layer includes a negative electrode active material that intercalates a charge carrier during charging of the non-aqueous rechargeable battery, and the separator is configured to hold a non-aqueous electrolyte solution; and
injecting the non-aqueous electrolyte solution into a case accommodating the electrode body, wherein
in the electrode body manufactured in the manufacturing an electrode body,
a coefficient of static friction between the negative electrode mixture layer and the separator is greater than or equal to 0.60, and
a coefficient of static friction between the positive electrode mixture layer and the separator is less than or equal to 0.50.
